(19) United States
(12) Patent Application Publication
(10) Pub. No.: US 2013/0169195 A1
(43) Pub. Date: Jul. 4, 2013

(54) UHV slit

(71) Applicant: Alex Deyhim, Ithaca, NY (US)

(72) Inventor: Alex Deyhim, Ithaca, NY (US)

(21) Appl. No.: 13/374,501

(22) Filed: Dec. 30, 2011

(51) Int. Cl. H02K 7/14

(52) U.S. Cl. 318/3

(57) ABSTRACT

Advanced Design Consulting, Inc. (ADC) has designed a slit where high accuracy is required. The system consists of vertical and horizontal slit mechanisms, a double sided flange which houses them, stepper motors with linear encoders, limit (home position) switches and electrical connections including internal wiring for a drain current measurement system. The total slit size is adjustable from 0 to 30 mm both vertically and horizontally depending on the flange size. Each of the four blades are individually controlled and motorized.

### CROSS REFERENCE TO RELATED APPLICATIONS

Not applicable

### STATEMENT REGARDING FEDERALLY SPONSORED RESEARCH OR DEVELOPMENT

Not applicable

### SEQUENCE LISTING OR PROGRAM

Not applicable

### BACKGROUND OF THE INVENTION

Described herein is a new monochromatic slit designed to obtain a well-defined narrow beam, such that is essential in Small Angle X-ray Scattering (SAXS) experiments. These guard slits are used to remove the fringes and diffraction effects from the first slits and to limit the background interference. The aperture is defined by 4 independently movable highly polished blades. The respective location of the blades are staggered such that the blades can pass over each other and thus ensure complete closure of the slit, without damaging the blades. These slits are only exposed to monochromatic beams and so will not require water cooling. The jaws are electrically isolated to allow drain current measurements for beam position monitoring.

### SUMMARY OF THE INVENTION

The UHV slit, ultra high vacuum, described herein has several constituents which makeup to totality of the invention. These components will be described further and include slit and slit blades, actuator, controller/driver and drain current measurement.

### BRIEF DESCRIPTION OF DRAWINGS

The invention as described herein with references to subsequent drawings, contains similar reference characters intended to designate like elements throughout the depictions and several views of the depictions. It is understood that in some cases, various aspects and views of the invention may be exaggerated or blown up (enlarged) in order to facilitate a common understanding of the invention and its associated parts.

FIG. 1 shows the schematic of the UHV Slit from the top angle.

FIG. 2 shows the schematic of the UHV Slit close up.

### DETAILED DESCRIPTION OF INVENTION

Provided herein is a detailed description of one embodiment of the invention. Therefore, specific details enclosed herein are not to be interpreted as limiting, but rather as a basis for the claims and as a representative basis for teaching one skilled in the art to employ the present invention in virtually any appropriately detailed system, structure, or manner.

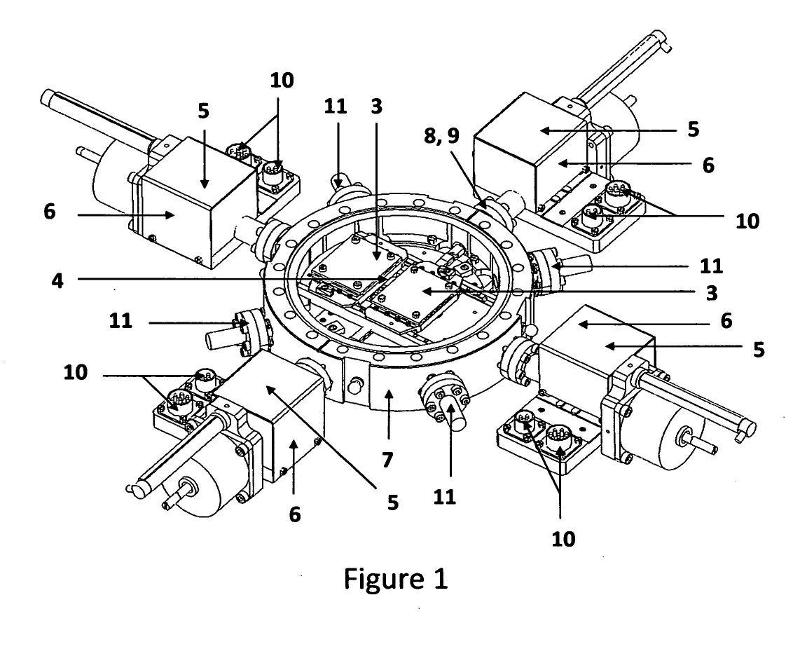

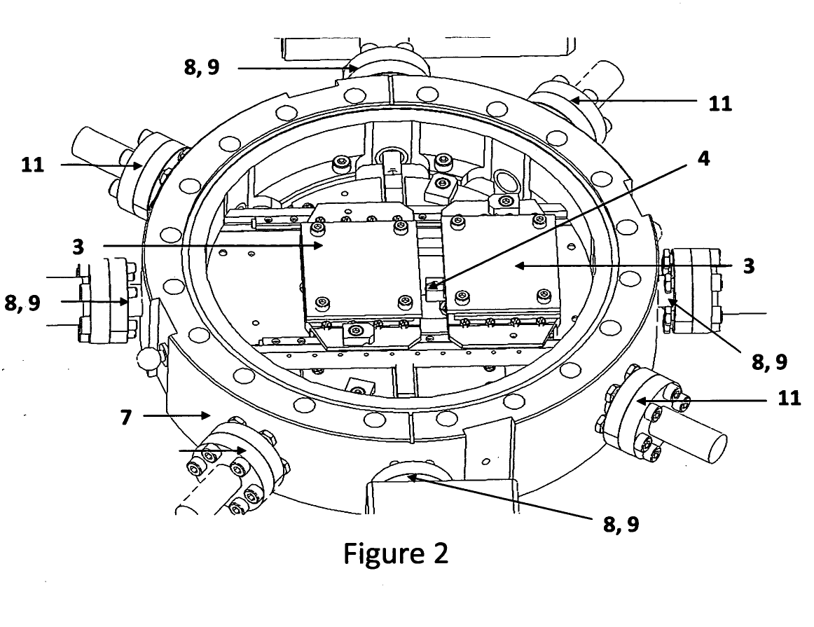

Blades 3, four, for the UHV slit are made from a machineable tungsten alloy, specifically 95% W, 3.5% Ni, 1.5% Cu. Each is wire EDM machined to shape followed by milling the surface relief and a preliminary grinding. After each blade is prepared, it undergoes a proprietary polishing process to give the highest quality knife-edge available in the synchrotron community. Two of the four blades of this embodiment are visible in both FIGS. 1 and 2, due to the overlapping caused when blades form the aperture 4 in which the beam passes.

The blade polishing process begins with a grinding operation designed to minimize the amount of material that must be removed during polishing. An edge and one of the faces are ground to an interior angle of 88° and then a second grinding operation relieves the face. Grinding produces an edge that is straight and true, but with pits and scratches that must be removed by polishing. Fixturing the slit is critical when polishing. The fixture must be extremely hard so that material is removed only from the blades, otherwise the knife-edge can become rounded. Two or more blades are usually polished together in a matched set to maintain parallelism. Both surfaces must be accessible without removing the blade as repositioning is impossible within the necessary tolerances.

Scratches are removed using a Buehler low-speed polisher with silicon carbide paper and polycrystalline diamond suspensions on fabrics of differing lumps. As finer grits are used the blades and fixturing must be thoroughly cleaned in an ultrasonic bath to remove larger particles. A final polish with colloidal silica is used when surface finish is critical. Wheel speed, applied force and polishing time varies with each step and is critical to the final quality. Too large a force leads to grain pull-out with Tungsten, which is extremely soft (Vickers hardness of 873). Relatively large force and long polishing time are required for Tantalum (Vickers hardness of 3430) yet over-polishing results in “orange-peel” that destroys the knife-edge.

The UHV Slit design incorporates both vertical and horizontal slit mechanisms, housed by a double sided flange 7, using a total of four blades for the overall design. The flange serves as a vacuum vessel when overall embodiment is set up. Blades 3 are respectively arranged in a staggered configuration so that the blades can pass over one another and thus ensure complete closure of the slit. Each of the four blades is individually controlled and motorized using a CTL-100-multi-axis stepper controller module 5, seen in FIG. 1, for a total of four controller modules.

This module is a high-performance, integrated motion controller and driver offering outstanding trajectory accuracy and exceptional programming functionality. It combines simplicity of operation with advanced features to precisely control the most diverse displacement and synchronize them via measurement, command, or external acquisition strings. Supplying 500 W of motor drive power, the CTL-100 can simultaneously handle up to four axes of motion using stepping motors. Each motion controller driver has two electrical connections 10 for drain current measurement system, visible in FIG. 1.

The CTL-100 uses a MicroLYNX Integrated Microstepping Motor Drive and High-Performance Machine/Process Controller. The MicroLYNX motion control system integrates a bipolar stepper motor microstepping drive and a versatile programmable indexer with expandable I/O and multiple communication ports all running off a single supply. The MicroLYNX4 runs at +12 to +48 VDC with 3 A RMS (4A peak) output and the MicroLYNX-7 runs at +24 to +75 VDC with 5A RMS (7A peak) output.

The CTL-100 provides several modes of positioning including synchronized and nonsynchronized point-to-point movement and jogging. Acceleration and deceleration rates are programmable on the fly as well as motor running, holding, and acceleration current. Encoder feedback can be used to make end-of-move position correction. Preprogrammed motion profiles can be synchronized to external events using IO functions.

The range of travel for each blade is from −3 mm to +30 mm depending on the size of the configuration. With modification, the blades can withstand a heat load of 5 watts. This modification precludes beam monitoring. Standard configuration does allow for beam monitoring, however, and in this configuration blades are independently, electrically isolated and have a connector and wire to enable beam monitoring. This is used to determine the position of the beam as it passed through the aperture 4 created by the four overlapping slit blades. The minimum DC resistance between the blade and earth is >1010 ohms. The vacuum vessel, double sided flange 7, contains four ports 11 for feedthroughs for drain current measurement.

The UHV Slit uses cross-roller bearing technology for exceptional straightness of travel of all four blades. A spring-extended linear encoder 6 with built-in home position is provided for each individual blade, within each module seen in FIG. 1. The accuracy of the linear encoder is +/−1 micron. An easily visible linear scale for each blade is attached to its translation system to provide an alternate way of reading the blade position, unfortunately not visible in any of the figures. Limit switches and hard stops prevent damage by over-travel.

The four blades are electrically conducting and insulated from the vacuum vessel. Each such blade is connected to a feedthrough 8 with a standard BNC connector 9, within. The signal current resulting from the beam hitting the blades is in the milli- to micro-amp range per blade. The drive assembly uses stepper motor actuation and crossed-roller bearings. All UHV sections are vacuum tested to better than 5×10−9 torr.

What is claimed is:

1. A UHV, ultra high vacuum, slit comprising:
(a) A double sided flange;
(b) Four slit blades;
(c) Four stepper motors;
(d) Four linear encoders;
(e) Four ports.

2. The apparatus of claim 1 wherein said double sided flange serves as the vacuum vessel.

3. The apparatus of claim 2 wherein said flange houses the four slit blades of claim 1.

4. The apparatus of claim 1 wherein said slit blades are comprised of tungsten alloy.

5. The apparatus of claim 4 wherein said blades are polished using a custom polishing procedure to provide the sharpest knife edge possible for better beam alignment.

6. The apparatus of claim 4 where wherein said slit blades are arranged in a staggered formation such that when actuated to form the specified aperture, blades can overlap.

7. The apparatus of claim 4 wherein said slit blades are arranged in vertical and horizontal configurations within said flange of claim 1.

8. The apparatus of claim 1 wherein said stepper motors control each slit blade individually.

9. The apparatus of claim 8 wherein said stepper motors are CTL-100-multi-axis stepper controller modules.

10. The apparatus of claim 8 wherein said stepper motors individually provide 500 watts of power to each slit blade of claim 1.

11. The apparatus of claim 8 wherein said stepper motors each contain hard stops and limit switches to prevent damage by over-travel.

12. The apparatus of claim 8 wherein each stepper motor contains two electrical connections for drain current measurement.

13. The apparatus of claim 8 wherein each said stepper motor is attached to each blade through a feedthrough and BNC connector.

14. The apparatus of claim 1 wherein said linear encoders are incorporated within the stepper motor modules.

15. The apparatus of claim 14 wherein said linear encoders are spring-extended linear encoders with built in home positions in order to read blade position within double sided flange.

16. The apparatus of claim 14 wherein the accuracy of each linear encoder is +/−1 micron.

17. The apparatus of claim 1 wherein said ports are connected to the double sided flange of claim 1 for the purpose of drain current measurement.

18. The apparatus of claim 1 wherein said UHV Slit components are all vacuum tested to better than 5×10−9 torr.
